(19) United States
(12) Patent Application Publication
(10) Pub. No.: US 2018/0029907 A1
(43) Pub. Date: Feb. 1, 2018

(54) WATER TREATMENT METHOD AND WATER TREATMENT SYSTEM

(71) Applicant: SUMITOMO ELECTRIC INDUSTRIES, LTD., Osaka-shi, Osaka (JP)

(72) Inventors: Keiichi IKEDA, Osaka (JP); Kiyoshi IDA, Osaka (JP); Toru MORITA, Osaka (JP)

(73) Assignee: SUMITOMO ELECTRIC INDUSTRIES, LTD., Osaka-shi, Osaka (JP)

(21) Appl. No.: 15/550,829

(22) PCT Filed: Nov. 10, 2016
(86) PCT No.: PCT/JP2016/083393

§ 371 Date: Aug. 14, 2017

(30) Foreign Application Priority Data
Dec. 22, 2015 (JP) 2015-250337

(51) Int. Cl. C02F 1/78; C02F 1/52; B01D 63/06; C02F 1/44; C02F 9/00

(52) U.S. Cl. CPC C02F 1/78; C02F 1/44; C02F 9/00; B01D 63/06; C02F 1/5236; C02F 2303/18; C02F 2101/203

(57) ABSTRACT

A water treatment method according to the present invention is a water treatment method in which oil is membrane-separated from water to be treated containing the oil and ferrous ions, the water treatment method including an oxidation step of oxidizing the ferrous ions in the water to be treated, and a filtration step of membrane-filtering the water to be treated after the oxidation step. In the oxidation step, a pH of the water to be treated is adjusted to 6 to 9, and an oxidation-reduction potential of the water to be treated is adjusted to 450 to 750 mV.

### TECHNICAL FIELD

The present invention relates to a water treatment method and a water treatment system. The present application is based upon and claims the benefit of priority from Japanese Patent Application No. 2015-250337, filed Dec. 22, 2015, the entire contents of which are incorporated herein by reference.

### BACKGROUND ART

Regarding oil-water mixtures (associated water) containing oil and suspended solids produced in oil fields and the like, from the viewpoint of environmental protection, the amounts of oil and suspended solids mixed must be reduced to predetermined values or less before disposal. Examples of a method for separating and removing oil and suspended solids from oil-water mixtures include gravity separation, distilled separation, and chemical separation.

Among these separation methods, as a means for separating and removing fine oil and the like on the downstream side of a separation step, a water treatment using a separation membrane is employed. As the separation membrane, for example, a filtration module in which a plurality of hollow-fiber membranes are bundled together can be used (refer to Japanese Unexamined Patent Application Publication No. 2010-42329).

### CITATION LIST

### Patent Literature

PTL 1: Japanese Unexamined Patent Application Publication No. 2010-42329

### SUMMARY OF INVENTION

### Solution to Problem

A water treatment method according to an embodiment of the present invention is a water treatment method in which oil is membrane-separated from water to be treated containing the oil and ferrous ions, the water treatment method including an oxidation step of oxidizing the ferrous ions in the water to be treated, and a filtration step of membrane-filtering the water to be treated after the oxidation step. In the oxidation step, a pH of the water to be treated is adjusted to 6 to 9, and an oxidation-reduction potential of the water to be treated is adjusted to 450 to 750 mV.

Furthermore, a water treatment system according to another embodiment of the present invention is a water treatment system in which oil is membrane-separated from water to be treated containing the oil and ferrous ions, the water treatment system including oxidation equipment configured to oxidize the ferrous ions in the water to be treated, and a filtration apparatus configured to membrane-filter the water to be treated which has been oxidized. The oxidation equipment has a mechanism to adjust a pH of the water to be treated to 6 to 9 and an oxidation-reduction potential of the water to be treated to 450 to 750 mV.

### BRIEF DESCRIPTION OF DRAWINGS

FIG. 1 is a schematic diagram showing a water treatment system according to an embodiment of the present invention.

FIG. 2 is a schematic diagram showing a water treatment system according to an embodiment different from that of the water treatment system shown in FIG. 1.

FIG. 3 is a schematic diagram showing a water treatment system according to an embodiment different from that of the water treatment system shown in FIG. 1 or 2.

FIG. 4 is a schematic diagram showing a water treatment system according to an embodiment different from that of the water treatment system shown in FIG. 1, 2, or 3.

FIG. 5 is a photograph of treated waters after filtration in Example 1 and Comparative Example 1.

FIG. 6 is a photograph of treated waters after filtration in Example 2 and Comparative Example 2.

### REFERENCE SIGNS LIST

1, 11, 21, 31 water treatment system
2 oxidation equipment
2a oxidation tank
2b oxidant supplier
2c de-oxidizing agent tower
2d measuring instrument
2e adjustment mechanism
2f diffuser pipe
3, 23 filtration apparatus
3a, 23a filtration module
3b, 23b buffer tank
3c, 23c pump for filtration
4 storage tank
5 transfer pump
6 aerator
6a aeration tank
6b, 23d gas supply device
6c, 23e second measuring instrument
6d, 23f second adjustment mechanism
6e, 23g diffuser pipe

### DESCRIPTION OF EMBODIMENTS

### Problems to be Solved by the Present Disclosure

In a separation membrane such as the one disclosed in the patent application publication described above, it is possible to effectively remove insoluble oil contained in the associated water. However, the associated water often contains ferrous ions. The ferrous ions pass through the separation membrane and then are oxidized and precipitated as ferric hydroxide in water. Therefore, in existing water treatment methods, treated water after filtration with a separation membrane becomes turbid, which is a problem.

The present invention has been accomplished under these circumstances. It is an object of the invention to provide a water treatment method and a water treatment system in which it is possible to remove oil from water to be treated and it is possible to prevent treated water from becoming turbid.

### Advantageous Effects of the Present Disclosure

In a water treatment apparatus and a water treatment system according to the present disclosure, it is possible to remove oil from water to be treated and it is possible to prevent treated water from becoming turbid.

### DESCRIPTION OF EMBODIMENTS OF THE PRESENT INVENTION

A water treatment method according to an embodiment of the present invention is a water treatment method in which oil is membrane-separated from water to be treated containing the oil and ferrous ions, the water treatment method including an oxidation step of oxidizing the ferrous ions in the water to be treated, and a filtration step of membrane-filtering the water to be treated after the oxidation step. In the oxidation step, a pH of the water to be treated is adjusted to 6 to 9, and an oxidation-reduction potential of the water to be treated is adjusted to 450 to 750 mV.

Since the water treatment method includes, before the filtration step, the oxidation step of oxidizing ferrous ions in water to be treated, ferrous ions can be precipitated as ferric hydroxide and the like by the oxidation step and can be separated together with oil by a filtration membrane. Therefore, in the water treatment method, it is possible to remove oil from water to be treated and it is possible to prevent filtered water from becoming turbid. Furthermore, in the water treatment method, in the oxidation step, the pH and the oxidation-reduction potential (ORP) of the water to be treated are adjusted within the ranges described above to bring about an environment in which ferrous ions are likely to be oxidized, and oxidation thereof is promoted. Accordingly, the effect of preventing water from becoming turbid can be markedly obtained. The term “oxidation-reduction potential” means a potential measured using a silver/silver chloride electrode.

In the oxidation step, ozone, chlorine, hydrogen peroxide, or hypochlorous acid may be brought into contact with the water to be treated. By using the oxidizing agent described above in the oxidation step, ferrous ions can be easily and reliably oxidized at a relatively low cost.

The water treatment method may further include an aeration step of aerating the water to be treated after the oxidation step. By aerating the water to be treated after the oxidation step, the oxidizing agent incorporated into the water to be treated in the oxidation step can be released as a gas phase and removed from the water to be treated. As a result, the separation membrane used in the filtration step can be prevented from being deteriorated, and treatment efficiency can be improved.

The aeration may be performed by using air or nitrogen gas. By performing aeration by using such gas, the oxidizing agent can be removed at a relatively low cost.

In the aeration step, the pH of the water to be treated may be adjusted to 6 to 9, and the oxidation-reduction potential of the water to be treated may be adjusted to 0 to 300 mV. In the aeration step, by adjusting the pH and the oxidation-reduction potential of the water to be treated after the oxidation step within the ranges described above, the separation membrane can be more reliably prevented from being deteriorated, and separation efficiency can be improved.

A water treatment system according to another embodiment of the present invention is a water treatment system in which oil is membrane-separated from water to be treated containing the oil and ferrous ions, the water treatment system including oxidation equipment configured to oxidize the ferrous ions in the water to be treated, and a filtration apparatus configured to membrane-filter the water to be treated which has been oxidized. The oxidation equipment has a mechanism to adjust a pH of the water to be treated to 6 to 9 and an oxidation-reduction potential of the water to be treated to 450 to 750 mV.

In the water treatment system, ferrous ions in the water to be treated can be precipitated as ferric hydroxide and the like by the oxidation equipment and can be separated together with oil by the filtration apparatus. Therefore, in the water treatment system, it is possible to remove oil from water to be treated and it is possible to prevent filtered water from becoming turbid. Furthermore, in the water treatment system, the oxidation equipment adjusts the pH and the oxidation-reduction potential (ORP) of the water to be treated within the ranges described above to bring about an environment in which ferrous ions are likely to be oxidized, and oxidation thereof is promoted. Accordingly, the effect of preventing water from becoming turbid can be markedly obtained.

### DETAILED DESCRIPTION OF EMBODIMENTS OF THE PRESENT INVENTION

Water treatment systems and water treatment methods according to embodiments of the present invention will be described below with reference to the drawings.

[Water Treatment System According to First Embodiment]

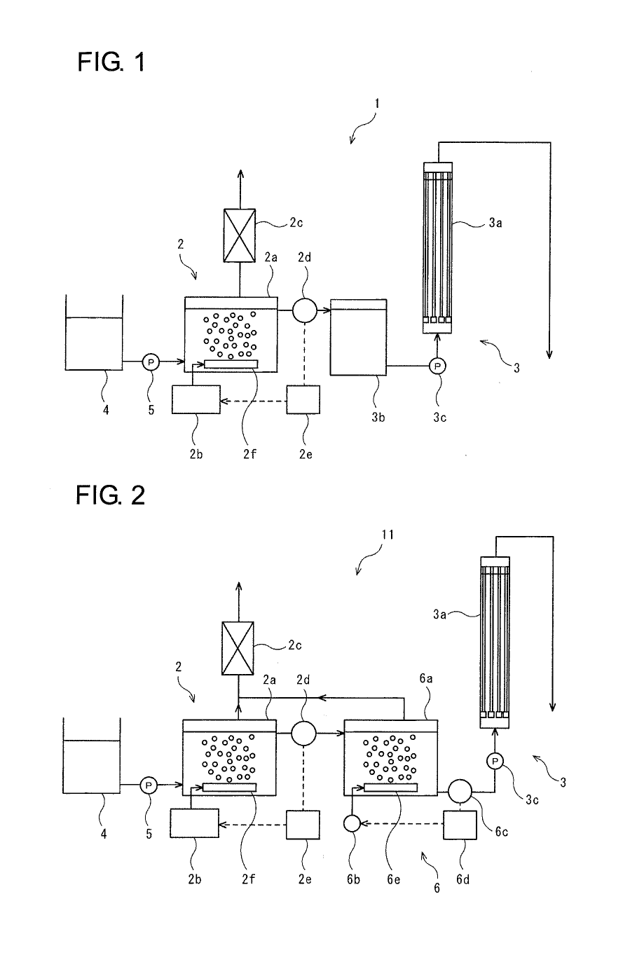

A water treatment system 1 shown in FIG. 1 is a water treatment system in which oil is membrane-separated from water to be treated containing the oil and ferrous ions. The water treatment system 1 includes mainly oxidation equipment 2 configured to oxidize the ferrous ions in the water to be treated, and a filtration apparatus 3 configured to membrane-filter the water to be treated which has been oxidized. The water treatment system 1 further includes a storage tank 4 which stores the water to be treated, and a transfer pump 5 which transfers the water to be treated from the storage tank 4 to the oxidation equipment 2.

<Water to be Treated>

The water to be treated which is a target of treatment in the water treatment system 1 is water containing oil and ferrous ions and, for example, is associated water produced in oil fields and the like. In general, the associated water produced in oil fields has a pH of 4 to 10.

<Oxidation Equipment>

The oxidation equipment 2 oxidizes ferrous ions in the water to be treated by using an oxidizing agent. The oxidation equipment 2 includes an oxidation tank 2a, an oxidant supplier 2b, a de-oxidizing agent tower 2c, a measuring instrument 2d which measures the pH and the oxidation-reduction potential, and an adjustment mechanism 2e which adjusts the pH and the oxidation-reduction potential of the water to be treated.

(Oxidizing Agent)

The oxidizing agent used in the oxidation equipment 2 is not particularly limited as long as it can oxidize ferrous ions and precipitate them as compounds, and is preferably ozone, chlorine, hydrogen peroxide, or hypochlorous acid. By using these oxidizing agents, oxidation can be easily and reliably performed at a relatively low cost, and removal from the water to be treated can be relatively easily performed. Among the oxidizing agents, ozone is particularly preferable from the viewpoint of high oxidizing power and ability to reliably oxidize ferrous ions in a short period of time.

(Oxidation Tank)

The oxidation tank 2a is a tank for bringing an oxidizing agent into contact with the water to be treated to oxidize ferrous ions. In the case where a gas, such as ozone or chlorine, is used as the oxidizing agent, as shown in FIG. 1, a diffuser pipe 2f is arranged on the bottom of the oxidation tank 2a, and the oxidizing agent is ejected from the diffuser pipe 2f so as to be in contact with the water to be treated. Furthermore, in the case where a liquid, such as hydrogen peroxide or sodium hypochlorite, or a solid, such as calcium hypochlorite, is used as the oxidizing agent, the oxidation tank 2a is provided with an oxidizing agent injection port, and the oxidizing agent is injected therethrough into the water to be treated.

A supply passage from the storage tank 4, which will be described later, is connected to a lower part of the oxidation tank 2a, and a supply passage to a buffer tank 3b of the filtration apparatus 3, which will be described later, is connected to an upper part of the oxidation tank 2a.

(Oxidant Supplier)

The oxidant supplier 2b is a device which supplies an oxidizing agent to the oxidation tank 2a. In the case where a gas, such as ozone or chlorine, is used as the oxidizing agent, the oxidant supplier 2b includes a mechanism which generates such a gas (oxidizing agent). Furthermore, in the oxidant supplier 2b, as shown in FIG. 1, by pressure-feeding the gas to the diffuser pipe 2f arranged on the bottom of the oxidation tank 2a, the oxidizing agent is ejected from the diffuser pipe 2f and brought into contact with the water to be treated in the oxidation tank 2a, thus being dissolved. Furthermore, the oxidant supplier 2b may be configured to include a container which stores an oxidizing agent itself and a supply mechanism therefor.

(De-Oxidizing Agent Tower)

In the case where a gas is used or a material that generates a gas is used as the oxidizing agent, the de-oxidizing agent tower 2c removes some components (harmful components and the like) of the gas generated by the supply of the oxidizing agent from the oxidation tank 2a. The gas whose harmful components and the like have been removed by the de-oxidizing agent tower 2c is released to the atmosphere. As the de-oxidizing agent tower 2c, a known de-oxidizing agent tower can be used depending on the type of oxidizing agent to be used.

(Measuring Instrument)

The measuring instrument 2d is arranged in the supply passage extending from the oxidation tank 2a to the buffer tank 3b of the filtration apparatus 3, and measures the pH and the oxidation-reduction potential of the water to be treated which is transferred from the oxidation tank 2a to the filtration apparatus 3. As the measuring instrument 2d, a known sensor or the like can be used.

(Adjustment Mechanism)

The adjustment mechanism 2e adjusts the pH and the oxidation-reduction potential of the water to be treated, which are measured by the measuring instrument 2d, within the predetermined ranges.

The lower limit of the pH of the water to be treated, which is adjusted by the adjustment mechanism 2e, is preferably 6 and more preferably 7. On the other hand, the upper limit of the pH is preferably 9 and more preferably 8.5. When the pH is less than the lower limit, there is a concern that a portion of ferric hydroxide may be dissociated into ions and may pass through the separation membrane. Contrarily, when the pH exceeds the upper limit, pH adjustment may become difficult, resulting in an excessive increase in the treatment cost.

The lower limit of the oxidation-reduction potential of the water to be treated, which is adjusted by the adjustment mechanism 2e, is preferably 450 mV, more preferably 500 mV, and still more preferably 550 mV. On the other hand, the upper limit of the oxidation-reduction potential is preferably 750 mV, more preferably 700 mV, and still more preferably 650 mV. When the oxidation-reduction potential is less than the lower limit, there is a concern that ferrous ions may be insufficiently oxidized. Contrarily, when the oxidation-reduction potential exceeds the upper limit, there is a concern that adjustment of the oxidation-reduction potential may become difficult, resulting in an excessive increase in the treatment cost.

As the method of adjusting the pH and the oxidation-reduction potential of the water to be treated, for example, the amounts of an oxidizing agent, a pH adjuster, and the like added may be adjusted. The pH adjuster is an acid or alkali. As the acid, an inorganic acid, such as hydrochloric acid or sulfuric acid, is preferable, and as the alkali, sodium hydroxide, potassium hydroxide, or the like is preferable.

<Filtration Apparatus>

The filtration apparatus 3 membrane-filters water to be treated by using a separation membrane. The filtration apparatus 3 includes a filtration module 3a, a buffer tank 3b, and a pump for filtration 3c.

(Filtration Module)

The filtration module 3a is an external-pressure-type filtration module in which water to be treated is made to pass through a separation membrane by the pressure of the pump for filtration 3c, thereby performing filtration. As the filtration module 3a, a known filtration module can be used. For example, a filtration module including a plurality of hollow-fiber membranes arranged in parallel in the upward-downward direction may be suitably used.

The hollow-fiber membranes are each obtained by forming, into a tubular shape, a porous membrane which allows a liquid to permeate therethrough and blocks permeation of impurities contained in water to be treated. As the hollow-fiber membranes, a material containing a thermoplastic resin as a main component can be used. Examples of the thermoplastic resin include polyethylene, polypropylene, polyvinylidene fluoride, ethylene-vinyl alcohol copolymers, polyamide, polyimide, polyetherimide, polystyrene, polysulfone, polyvinyl alcohol, polyphenylene ether, polyphenylene sulfide, acetylcellulose, polyacrylonitrile, and polytetrafluoroethylene (PTFE). Among these, preferable is PTFE which is excellent in terms of mechanical strength, chemical resistance, heat resistance, weather resistance, flame resistance, and the like and which is porous, and more preferable is uniaxially or biaxially expanded PTFE. Other polymers and additives such as a lubricant may be appropriately mixed into the material for forming the hollow-fiber membrane.

The upper limit of the mean pore diameter of the hollow-fiber membranes is preferably 1 m, and more preferably 0.5 m. On the other hand, the lower limit of the mean pore diameter of the hollow-fiber membranes is preferably 0.01 μm. When the mean pore diameter of the hollow-fiber membranes exceeds the upper limit, there is a concern that it may not be possible to prevent impurities contained in water to be treated from permeating into the hollow-fiber membranes. Contrarily, when the mean pore diameter of the hollow-fiber membranes is less than the lower limit, there is a concern that permeability may be decreased. Note that the mean pore diameter refers to the mean pore diameter on the outer peripheral surfaces (surfaces of the filtration layers) of the hollow-fiber membranes and can be measured by a pore diameter distribution measurement device (e.g., porous material automatic pore diameter distribution measuring system, manufactured by Porous Materials, Inc).

(Buffer Tank)

The buffer tank 3b is a tank that receives the water to be treated, which has been oxidized, from the oxidation tank 2a. The water to be treated, which is stored in the buffer tank 3b, is supplied to the filtration module 3a by the pump for filtration 3c. The volume of the buffer tank 3b is not particularly limited, and is preferably equal to or greater than the volume of the oxidation tank 2a.

(Pump for Filtration)

The pump for filtration 3c supplies the water to be treated, which is stored in the buffer tank 3b, at a certain water pressure to the filtration module 3a so that the water to be treated can pass through the separation membrane. The discharge pressure of the pump for filtration 3c is appropriately designed depending on the treatment performance of the water treatment system 1 and the like.

<Storage Tank>

The storage tank 4 stores the water to be treated and supplies it to the oxidation equipment 2.

<Transfer Pump>

The transfer pump 5 is arranged in the supply passage extending from the storage tank 4 to the oxidation equipment 2 and transfers the water to be treated to the oxidation tank 2a.

[Water Treatment Method According to First Embodiment]

Next, a description will be made regarding a water treatment method according to an embodiment of the present invention in which the water treatment system 1 shown in FIG. 1 is used. The water treatment method is a water treatment method in which oil is membrane-separated from water to be treated containing the oil and ferrous ions, the water treatment method including an oxidation step of oxidizing the ferrous ions in the water to be treated, and a filtration step of membrane-filtering the water to be treated after the oxidation step.

<Oxidation Step>

In the oxidation step, by using the oxidation equipment 2, mainly ferrous ions in the water to be treated, which is transferred from the storage tank 4, are oxidized. Furthermore, in the oxidation step, the pH and the oxidation-reduction potential of the water to be treated are measured by the measuring instrument 2d, the pH is adjusted to 6 to 9, and the oxidation-reduction potential is adjusted to 450 to 750 mV.

The ranges of the pH and the oxidation-reduction potential of the water to be treated in the oxidation step and the adjustment method therefor are the same as those described above regarding the water treatment system.

The amount of the oxidizing agent supplied to the oxidation tank 2a, the contact time with the oxidizing agent, and the like are appropriately set depending on the content of ferrous ions in the water to be treated, the pH, the oxidation-reduction potential, and the like.

<Filtration Step>

In the filtration step, the water to be treated, which has been oxidized by the oxidation equipment 2, is membrane-filtered by the filtration apparatus 3.

In the water treatment method, the oxidation step and the filtration step may be carried out in a continuous manner or batchwise. Since the water treatment system 1 includes the storage tank 4 and the buffer tank 3b, by carrying out the treatment steps in a continuous manner, treatment efficiency can be improved.

Since the water treatment method includes, before the filtration step, the oxidation step of oxidizing ferrous ions in water to be treated, ferrous ions can be precipitated as ferric hydroxide and the like by the oxidation step and can be separated together with oil by a filtration membrane. Therefore, in the water treatment method, it is possible to remove oil from water to be treated and it is possible to prevent filtered water from becoming turbid. Furthermore, in the water treatment method, in the oxidation step, the pH and the oxidation-reduction potential of the water to be treated are adjusted within the ranges described above to bring about an environment in which ferrous ions are likely to be oxidized, and oxidation thereof is promoted. Accordingly, the effect of preventing water from becoming turbid can be markedly obtained.

[Water Treatment System According to Second Embodiment]

A water treatment system 11 shown in FIG. 2 includes mainly oxidation equipment 2 configured to oxidize ferrous ions in water to be treated, a filtration apparatus 3 configured to membrane-filter the water to be treated after oxidation, and an aerator 6 which aerates the water to be treated after oxidation and before filtration. The oxidation equipment 2 and the filtration apparatus 3 are the same as those in the water treatment system 1 shown in FIG. 1 except that the filtration apparatus 3 does not include a buffer tank 3b. Accordingly, they are denoted by the same reference signs, and a description thereof is omitted.

<Aerator>

The aerator 6 aerates the water to be treated after oxidation and removes the oxidizing agent. The aerator 6 includes an aeration tank 6a, a gas supply device 6b, a second measuring instrument 6c which measures the pH and the oxidation-reduction potential, and a second adjustment mechanism 6d which adjusts the pH and the oxidation-reduction potential of the water to be treated.

(Aeration Tank)

The aeration tank 6a is a tank for removing the oxidizing agent by bringing a gas into contact with the water to be treated to perform aeration. As shown in FIG. 2, a diffuser pipe 6e is arranged on the bottom of the aeration tank 6a, and the gas is ejected from the diffuser pipe 6e, thereby performing aeration of the water to be treated. Furthermore, the aeration tank 6a also serves as a buffer tank of the filtration apparatus 3.

A supply passage from the oxidation tank 2a is connected to an upper part of the aeration tank 6a, and a supply passage to the filtration apparatus 3 is connected to a lower part of the aeration tank 6a. Furthermore, a gas discharge passage is connected to the top of the aeration tank 6a. The gas discharge passage is connected to the de-oxidizing agent tower 2c of the oxidation equipment 2. Note that the gas discharge passage may be a passage which is independent from the oxidation equipment 2 and which is connected to a treatment tower that is different from the de-oxidizing agent tower 2c.

(Gas Supply Device)

The gas supply device 6b supplies a gas for aeration to the aeration tank 6a via a diffuser pipe 6e. The gas for aeration is not particularly limited as long as it does not reduce oxides in the water to be treated, and is preferably air or nitrogen gas from the viewpoint of handleability and cost.

In the case where air is used as the gas for aeration, a known device such as a compressor can be used as the gas supply device 6b. Furthermore, in the case where nitrogen gas or the like is used, the gas supply device 6b may be configured to include a container which stores such a gas and a mechanism for pressure-feeding the gas.

(Second Measuring Instrument)

The second measuring instrument 6c is arranged in the supply passage extending from the aeration tank 6a to the filtration module 3a, and measures the pH and the oxidation-reduction potential of the water to be treated which is transferred from the aeration tank 6a to the filtration apparatus 3. As the second measuring instrument 6c, an instrument that is the same as the measuring instrument 2d of the oxidation equipment 2 can be used.

(Second Adjustment Mechanism)

The second adjustment mechanism 6d adjusts the pH and the oxidation-reduction potential of the water to be treated, which are measured by the second measuring instrument 6c, within the predetermined ranges.

The lower limit of the pH of the water to be treated, which is adjusted by the second adjustment mechanism 6d, is preferably 6 and more preferably 7. On the other hand, the upper limit of the pH is preferably 9 and more preferably 8.5. When the pH is less than the lower limit or exceeds the upper limit, there is a concern that the separation membrane of the filtration module 3a may become deteriorated depending on the material of the membrane.

The lower limit of the oxidation-reduction potential of the water to be treated, which is adjusted by the second adjustment mechanism 6d, is preferably 0 mV, more preferably 50 mV, and still more preferably 100 mV. On the other hand, the upper limit of the oxidation-reduction potential is preferably 300 mV, more preferably 250 mV, and still more preferably 200 mV. When the oxidation-reduction potential is less than the lower limit, there is a concern that a portion of ferric hydroxide may be reduced to ferrous ions. Contrarily, when the oxidation-reduction potential exceeds the upper limit, there is a concern that the separation membrane of the filtration module 3a may become deteriorated depending on the material of the membrane.

As the method of adjusting the pH and the oxidation-reduction potential of the water to be treated in the aerator 6, for example, the amount of aeration and the amounts of a pH adjuster and the like added may be adjusted.

[Water Treatment Method According to Second Embodiment]

Next, a description will be made regarding a water treatment method according to an embodiment of the present invention in which the water treatment system 11 shown in FIG. 2 is used. The water treatment method includes an oxidation step of oxidizing ferrous ions in water to be treated, an aeration step of aerating the water to be treated after the oxidation step, and a filtration step of membrane-filtering the water to be treated after the aeration step.

The oxidation step and the filtration step are the same as those in the water treatment method according to the first embodiment, and hence a description thereof is omitted.

<Aeration Step>

In the aeration step, by using the aerator 6, the water to be treated transferred from the oxidation tank 2a is aerated. Furthermore, in the aeration step, the pH and the oxidation-reduction potential of the water to be treated are measured by the second measuring instrument 6c, and the pH is adjusted to 6 to 9, and the oxidation-reduction potential is adjusted to 0 to 300 mV.

The ranges of the pH and the oxidation-reduction potential of the water to be treated in the aeration step and the adjustment method therefor are the same as those described above regarding the water treatment system.

The amount of the gas supplied to the aeration tank 6a is appropriately set depending on the content of the oxidizing agent in the water to be treated, the pH, the oxidation-reduction potential, and the like.

In the water treatment method, by aerating the water to be treated after the oxidation step, the oxidizing agent incorporated into the water to be treated in the oxidation step can be released as a gas phase and removed from the water to be treated. As a result, the separation membrane used in the filtration step can be prevented from being deteriorated, and treatment efficiency can be improved.

[Water Treatment System According to Third Embodiment]

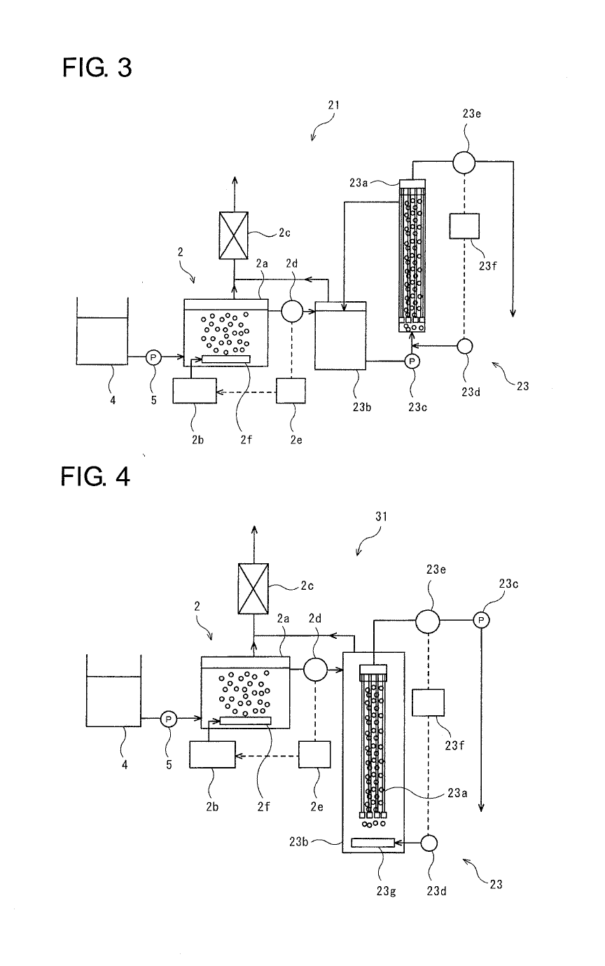

A water treatment system 21 shown in FIG. 3 includes mainly oxidation equipment 2 configured to oxidize ferrous ions in water to be treated and a filtration apparatus 23 configured to membrane-filter the water to be treated after oxidation. The filtration apparatus 23 in the water treatment system 21 also serves as an aerator. Since the oxidation equipment 2 is the same as that of the water treatment system 1 shown in FIG. 1, it is denoted by the same reference signs, and a description thereof is omitted.

<Filtration Apparatus>

The filtration apparatus 23 includes a filtration module 23a, a buffer tank 23b, a pump for filtration 23c, a gas supply device 23d, a second measuring instrument 23e, and a second adjustment mechanism 23f. The filtration module 23a, the buffer tank 23b, and the pump for filtration 23c are respectively the same as the filtration module 3a, the buffer tank 3b, and the pump for filtration 3c of the water treatment system 1 shown in FIG. 1.

The gas supply device 23d, the second measuring instrument 23e, and the second adjustment mechanism 23f of the filtration apparatus 23 respectively correspond to the gas supply device 6b, the second measuring instrument 6c, and the second adjustment mechanism 6d of the aerator 6 shown in FIG. 2. Furthermore, the filtration module 23a also serves as an aeration tank 6a of the aerator 6 shown in FIG. 2.

The gas supply device 23d supplies a gas to the downstream side of the pump for filtration 23c to aerate the water to be treated inside the filtration module 23a. Furthermore, a duct connected to the buffer tank 23b is provided on an upper part of the filtration module 23a, and a gas discharge passage, which is connected to the de-oxidizing agent tower 2c of the oxidation equipment 2, is connected to the top of the buffer tank 23b. This configuration allows the oxidizing agent in the water to be treated to be removed by aeration.

The second measuring instrument 23e is arranged in the discharge passage from the filtration module 23a, and measures the pH and the oxidation-reduction potential of the water to be treated which has been subjected to aeration and filtration. The second adjustment mechanism 23f adjusts the pH and the oxidation-reduction potential of the water to be treated within the predetermined ranges on the basis of the values measured by the second measuring instrument 23e. Adjustment ranges for the pH and the oxidation-reduction potential of the water to be treated can be set to be the same as those in the water treatment system 11 shown in FIG. 2.

[Water Treatment Method According to Third Embodiment]

A water treatment method according to an embodiment of the present invention, in which the water treatment system 21 shown in FIG. 3 is used, includes an oxidation step of oxidizing ferrous ions in water to be treated, an aeration step of aerating the water to be treated after the oxidation step, and a filtration step of membrane-filtering the water to be treated after the oxidation step. The aeration step and the filtration step are performed simultaneously.

In the water treatment system 21 and the water treatment method, since the water to be treated which has been oxidized is aerated inside the filtration module 23a, the separation membrane of the filtration module 23a can be simultaneously cleaned by the gas for aeration. Accordingly, the aerator of the filtration module 23a is allowed to also serve as a cleaning device, and thus, the equipment cost and running cost can be reduced.

### OTHER EMBODIMENTS

It should be considered that the embodiments disclosed this time are illustrative and non-restrictive in all aspects. The scope of the present invention is not limited to the embodiments described above but is defined by the appended claims, and is intended to include all modifications within the meaning and scope equivalent to those of the claims.

In the water treatment system, besides the external-pressure-type filtration module described above in each of the embodiments, in which the pressure is increased on the outer surface side of the separation membrane, and a liquid to be treated permeates toward the inner surface side of the separation membrane, various other filtration modules can be used. Examples thereof include an immersion-type filtration module in which a liquid to be treated permeates toward the inner surface side of the separation membrane by means of osmotic pressure or negative pressure on the inner surface side; and an internal-pressure-type filtration module in which the pressure is increased on the inner surface side of the separation membrane, and a liquid to be treated permeates toward the outer surface side of the separation membrane.

FIG. 4 shows an example in which an immersion-type filtration module is used in the water treatment system shown in FIG. 3. In a water treatment system 31 shown in FIG. 4, a filtration module 23a is immersed in a buffer tank 23b, and a pump for filtration 23c is arranged as a suction pump on the discharge side of the filtration module 23a. In the water treatment system 31, for example, by supplying a gas from a diffuser pipe 23g arranged on the bottom of the buffer tank 23b, aeration of water to be treated and cleaning of the separation membrane of the filtration module 23a can be performed.

Furthermore, in the water treatment method, in the oxidation treatment, ferrous ions in water to be treated may be oxidized by irradiation with light such as ultraviolet (UV).

Furthermore, in the water treatment method, oxidization treatment or aeration may be performed on the water to be treated which is flowing through the pipe, instead of the water to be treated inside a tank, such as the oxidation tank. In this case, the oxidation tank or the like can be omitted.

Furthermore, in the water treatment system, the de-oxidizing agent tower is not indispensable depending on the types of oxidizing agent and gas for aeration, and it may be possible to directly release the gas generated from each of the tanks.

Furthermore, the position at which the measuring instrument to measure the pH and the oxidation-reduction potential is arranged is not limited to the passage (pipe), and the measuring instrument may be arranged inside a tank, such as the oxidation tank, aeration tank, or buffer tank.

### EXAMPLES

The present invention will be described in more detail below on the basis of examples. However, it is to be understood that the present invention is not limited to the examples.

### Example 1

Ozone gas serving as an oxidizing agent was supplied at a flow rate of 5 L/min to 5 L of associated water from an oil field in China for 30 minutes while adjusting the pH to 8.0 and the oxidation-reduction potential to 650 mV, and then the water was filtered with a separation membrane. Regarding the treated water after filtration, the turbidity was measured, in accordance with the U.S. Standard Method 2130B, to be 0.19 NTU. “NTU” is an abbreviation for Nephelometric Turbidity Unit and is the unit of turbidity.

### Comparative Example 1

5 L of associated water from the oil field in China was filtered with a separation membrane without supplying ozone gas thereto. Regarding the treated water after filtration, the turbidity was measured to be 85 NTU.

### Example 2

Ozone gas serving as an oxidizing agent was supplied at a flow rate of 5 L/min to 5 L of associated water from a gas field in Japan for 30 minutes while adjusting the pH to 7.5 and the oxidation-reduction potential to 700 mV, and then the water was filtered with a separation membrane. Regarding the treated water after filtration, the turbidity was measured to be 0.83 NTU.

### Comparative Example 2

5 L of associated water from the gas field in Japan was filtered with a separation membrane without supplying ozone gas thereto. Regarding the treated water after filtration, the turbidity was measured to be 238 NTU.

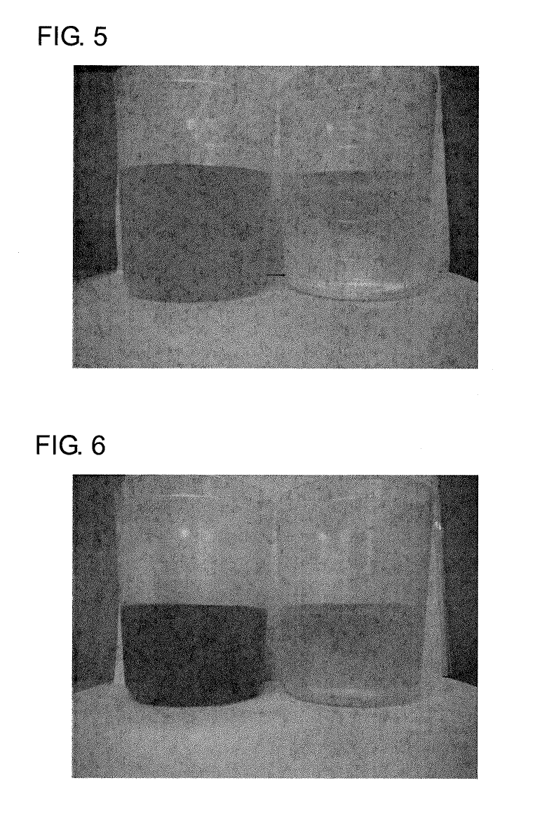

FIG. 5 is a photograph of treated waters after associated waters in Example 1 and Comparative Example 1 have been filtered. The image on the left side corresponds to Comparative Example 1, and the image on the right side corresponds to Example 1. Furthermore, FIG. 6 is a photograph of treated waters after associated waters in Example 2 and Comparative Example 2 have been filtered. The image on the left side corresponds to Comparative Example 2, and the image on the right side corresponds to Example 2. As is evident from the above results, by oxidizing associated water before filtration, precipitation of oxides from ferrous ions can be prevented after filtration, and the turbidity of filtered water can be greatly decreased.

1: A water treatment method in which oil is membrane-separated from water to be treated containing the oil and ferrous ions, the water treatment method comprising:
an oxidation step of oxidizing the ferrous ions in the water to be treated; and
a filtration step of membrane-filtering the water to be treated after the oxidation step,
wherein, in the oxidation step, a pH of the water to be treated is adjusted to 6 to 9, and an oxidation-reduction potential of the water to be treated is adjusted to 450 to 750 mV.

2: The water treatment method according to claim 1, wherein, in the oxidation step, ozone, chlorine, hydrogen peroxide, or hypochlorous acid is brought into contact with the water to be treated.

3: The water treatment method according to claim 1, further comprising an aeration step of aerating the water to be treated after the oxidation step.

4: The water treatment method according to claim 3, wherein the aeration is performed by using air or nitrogen gas.

5: The water treatment method according to claim 3, wherein, in the aeration step, the pH of the water to be treated is adjusted to 6 to 9, and the oxidation-reduction potential of the water to be treated is adjusted to 0 to 300 mV.

6: A water treatment system in which oil is membrane-separated from water to be treated containing the oil and ferrous ions, the system comprising:
oxidation equipment configured to oxidize the ferrous ions in the water to be treated; and
a filtration apparatus configured to membrane-filter the water to be treated which has been oxidized,
wherein the oxidation equipment has a mechanism to adjust a pH of the water to be treated to 6 to 9 and an oxidation-reduction potential of the water to be treated to 450 to 750 mV.
